(19) United States
(12) Patent Application Publication
(10) Pub. No.: US 2012/0152397 A1
(43) Pub. Date: Jun. 21, 2012

(54) Frame Tube for Light-Weighted Bicycle Frame

(76) Inventor: Ching-Chi Chung, Jiuru Township (TW)

(21) Appl. No.: 12/969,671

(22) Filed: Dec. 16, 2010

(51) Int. Cl. F16L 9/16

(52) U.S. Cl. 138/154

(57) ABSTRACT

A frame tube for a light-weighted bicycle frame includes a spiral tube body having multiple spiral turns and made by processing 6-4 titanium, ASTM A313 or ASTM A564 high-strength stainless steel alloy sheet material of thickness under 1 mm. Each two adjacent spiral turns of the spiral tube body is bonded together by welding. A plurality of pores is formed in the spiral tube body to reduce the weight of the frame tube and to enhance its shock-absorbing capability.

### BACKGROUND OF THE INVENTION

1. Field of the Invention

The present invention relates to a frame tube for a light-weighted bicycle frame and, more particularly, to such a frame tube that has the characteristic of lightweight and high shock-absorbing capability.

2. Description of the Related Art

Following the evolution of the times, a bicycle is no longer simply a personal transportable vehicle. Nowadays, a bicycle has been intensively used as a multipurpose tool for recreational and sports activities. Every government is urgently to establish bike lanes, bike routes, and cycle racing parts for bicycle riders. In consequence, bicycle suppliers are trying hard to create different designs of bicycles for different purposes.

In order to satisfy the requirements for high-strength and light-weighted bicycles, high-quality materials are continuously created. Except regular recreational bicycles, many consumers are willing to have a racing bike. To bicycle designers, it is important to improve the riding comfort and speed of their products. In order to enhance the riding speed of a bicycle, the weight of the bicycle frame body must be reduced.

Therefore, there is a strong demand to find a way that can reduce the weight of a bicycle while enhancing the riding comfort.

### BRIEF SUMMARY OF THE INVENTION

Thus, it is an objective of the present invention to solve this need and other problems in the field of light-weighted bicycle frames by providing a frame tube for a bicycle frame, which has the characteristic of high tensile strength, lightweight, and high shock-absorbing capability.

To achieve the foregoing objective, a frame tube of the present invention includes a spiral tube body having multiple spiral turns and formed from an alloy sheet material selected from the group of 6-4 titanium alloy sheet materials, ASTM A313, and ASTM A564 high-strength stainless steel alloy sheet materials. A welding bead or welded joint spirally extends around the spiral tube body to bond each two adjacent spiral turns of the spiral tube body together, and a plurality of pores is distributed over the spiral tube body to reduce the weight of the frame tube and to enhance its shock-absorbing capability.

In a preferred form, the pores formed in the tube body are round holes.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a schematic view illustrating a first preparation of a frame tube in accordance with the present invention.

FIG. 2 shows a schematic view illustrating a second preparation of the frame tube in accordance with the present invention.

FIG. 3 shows a schematic view illustrating a third preparation of the frame tube in accordance with the present invention.

FIG. 4 shows a perspective view of the frame tube in accordance with the present invention.

FIG. 5 illustrates a bicycle frame constructed by the frame tube in accordance with the present invention.

### DETAILED DESCRIPTION OF THE INVENTION

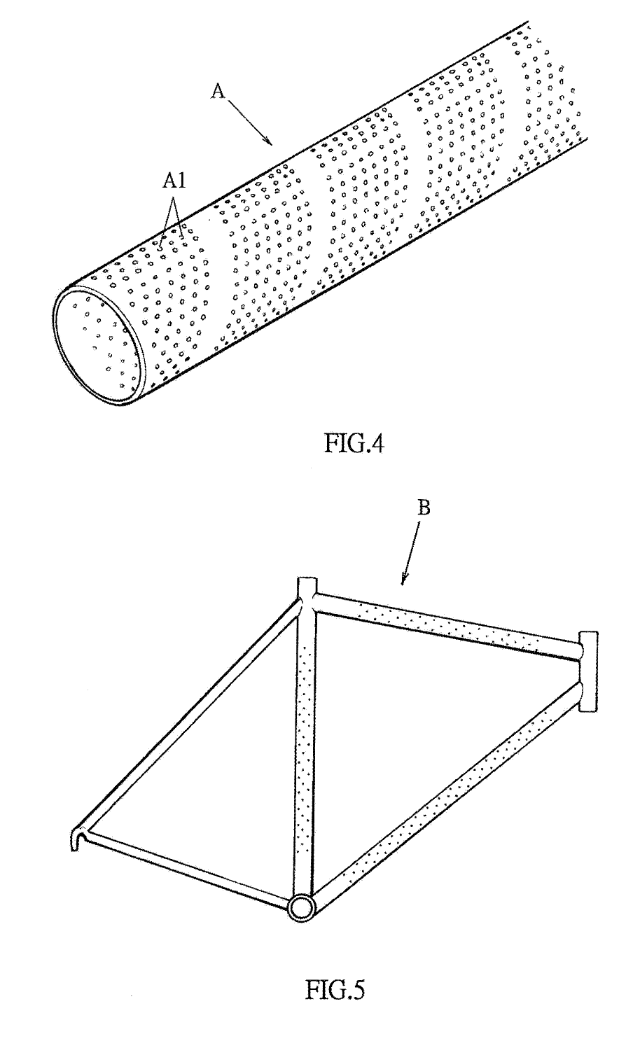

A frame tube for a light-weighted bicycle frame according to the preferred teachings of the present invention is shown in FIGS. 4 and 5 of the drawings and generally designated A. Frame tube A is made by processing an alloy sheet material. The terminology “alloy sheet material” refers to a 6-4 titanium (Ti) alloy sheet material or ASTM A313/ASTM A564 high-strength stainless steel alloy sheet material of thickness under 3 mm, in which 6-4 titanium alloy sheet material contains 6% aluminum, 4% alumina, and 90% titanium; ASTM standards are defined by American Society For Testing and Materials.

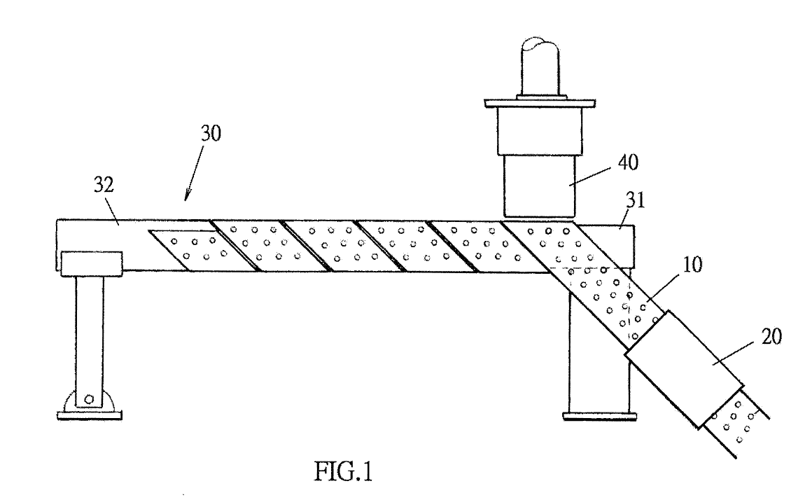

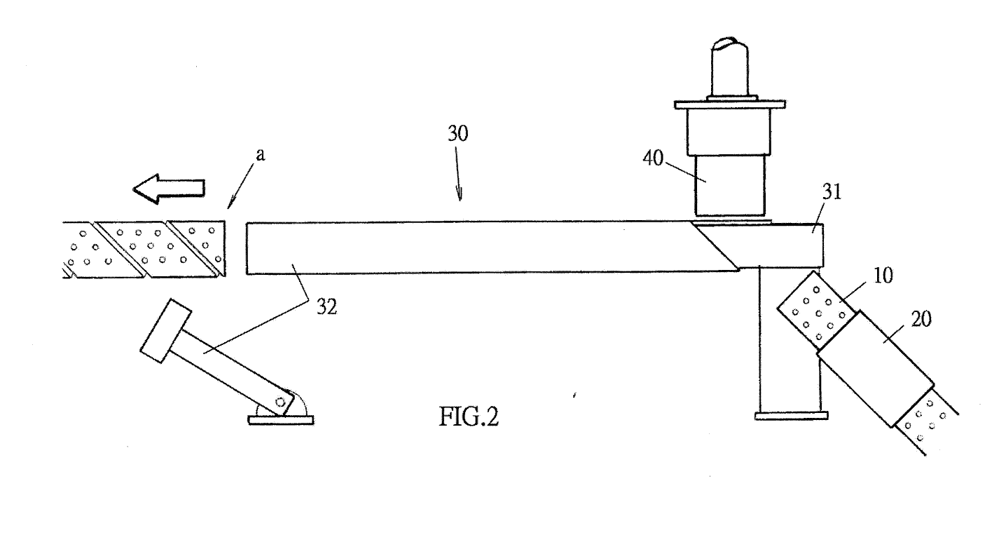

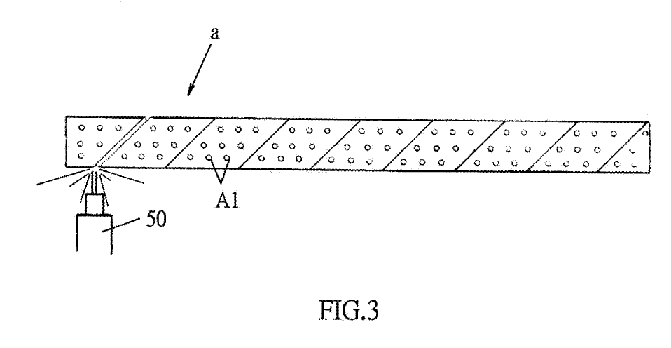

FIGS. 1 through 3 illustrate preparations or formations of frame tube A in accordance with the present invention. As illustrated, an alloy sheet material 10 is carried on a feeder 20 that is controlled to feed the alloy sheet material 10 to a forming mold 30. The forming mold 30 is a cylindrical bar having a front shape-forming end 31 and a rear discharge end 32, and used with a stamping die 40. The stamping die 40 is vertically reciprocated by a press (not shown) to stamp the alloy sheet material 10 against the forming mold 30. The feeder 20 feeds the alloy sheet material 10 to the forming mold 30 at a predetermined feeding angle, preferably within 40°˜45°. When the alloy sheet material 10 is being fed to the forming mold 30, it will be stamped to deform by the stamping die 40 against the forming mold 30. Deformation of the alloy sheet material 10 is determined subject to the shape of the forming mold 30 and the shape of the stamping die 40. The factor of the resilient-elasticity recovery (memory characteristic) of the metal must be taken into account. After stamping, a predetermined roundness is obtained. Under the operation of continuous material feeding and stamping, the alloy sheet material 10 is spirally rotated into a spiral tube body (a) that extends toward the rear discharge end 32 of the forming mold 30. After finish of the spiral tube body (a) subject to a predetermined specification (length), it is taken away from the forming mold 30 through the rear discharge end 32. Thereafter, each two adjacent spiral turns of the spiral tube body (a) are bonded together by a welding gun 50. After welding, a frame tube A is obtained. Further, the frame tube A is perforated to provide evenly distributed pores A1, reducing the weight.

Before formation of the frame tube A, the alloy sheet material 10 may be punched to provide the pores A1. Alternatively, the pores A1 can be formed by means of a hole-drilling or hole-punching technique after formation of the frame tube A. Further, the pores A1 can be any shape, preferably, the pores A1 are round holes.

The frame tube A is made by processing the alloy sheet material 10 into a spiral tube body (a) by means of cold rolling and stamping and then bonding each two adjacent spiral turns of the spiral tube body (a) together by a welding gun 50. The welding bead of the frame tube A extends evenly spirally around the frame tube A so that the stress is evenly distributed through the whole frame tube A, enhancing the strength and lowering the degree of deformation. Further, the distribution of the pores A1 over the surface of the frame tube A reduces the weight of the frame tube A and can release the stress to enhance the shock-absorbing capability of the frame tube A when the frame tube A receives an external stress. Therefore, the frame tube A that has high tensile strength, light weight, and high shock-absorbing capability is adapted for use to make a bicycle frame B (see FIG. 5) for a light-weighted bicycle, improving the quality and performance of the bicycle.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A frame tube for a light-weighted bicycle frame comprising a spiral tube body having multiple spiral turns and formed from an alloy sheet material selected from the group of 6-4 titanium alloy sheet materials, ASTM A313, and ASTM A564 high-strength stainless steel alloy sheet materials, with a welding bead spirally extending around said spiral tube body to bond each two adjacent spiral turns of said spiral tube body together, and with a plurality of pores distributed over said spiral tube body.

2. The frame tube according to claim 1, with said pores distributed in said tube body being round holes.
